(19) United States
(12) Patent Application Publication
(10) Pub. No.: US 2026/0109159 A1
(43) Pub. Date: Apr. 23, 2026

(54) MEDIUM CONVEYANCE DEVICE AND ELECTRONIC EQUIPMENT

(71) Applicant: SEIKO EPSON CORPORATION, TOKYO (JP)

(72) Inventor: Kazutoshi MATSUZAKI, SHIOJIRI-SHI (JP)

(21) Appl. No.: 19/365,326

(22) Filed: Oct. 22, 2025

(30) Foreign Application Priority Data
Oct. 23, 2024 (JP) 2024-186705

(51) Int. Cl. B41J 11/00; B41J 13/00; B41J 13/02; B41J 13/076; B41J 23/12

(52) U.S. Cl. CPC B41J 11/0055; B41J 13/009; B41J 13/025; B41J 13/076; B41J 23/12

(57) ABSTRACT

According to an aspect of the present disclosure, there is provided a medium conveyance device including a second conveyance roller pair disposed downstream in a conveyance direction of a first conveyance roller pair and a shutter unit including a contact section with which a leading end of a conveyed medium comes into contact upstream of a nip position of the second conveyance roller pair and displaceable to a first posture for correcting skew of the medium and a second posture for retracting the contact section such that the medium after the correction reaches the nip position, and a third conveyance roller pair disposed between the first conveyance roller pair and the contact section in the first posture. The third conveyance roller pair does not nip the medium before the leading end of the medium comes into contact with the contact section in the first posture of the shutter unit and nips and conveys the medium after the correction and when the shutter unit is displaced from the first posture to the second posture.

The present application is based on, and claims priority from JP Application Serial Number 2024-186705, filed Oct. 23, 2024, the disclosure of which is hereby incorporated by reference herein in its entirety.

### BACKGROUND

### 1. Technical Field

The present disclosure relates to a medium conveyance device and electronic equipment such as a printer.

### 2. Related Art

An example of the related art of the device of this type is disclosed in JP-A-2004-26343.

JP-A-2004-26343 discloses a recording medium conveyance device including a plurality of shutters that correct skew of a medium. The shutters include contact sections with which the leading end of the medium conveyed in the conveyance direction comes into contact. The shutters are configured to be displaceable to a contact position where the leading end of the medium comes into contact with the contact section and a retracted position where the contact section retracts to enable passage of the medium.

The medium advances in a conveyance direction when the contact section moves to the retracted position, the leading end of the medium is nipped by a conveyance roller, and the medium is conveyed toward a recording unit located downstream in the conveyance direction.

JP-A-2004-26343 is an example of the related art.

However, a nip position where the conveyance roller nips the leading end of the medium is close to the contact position in the conveyance direction but is not the same position as the contact position. For that reason, although the skew of the medium is corrected at the contact position, when the contact section is displaced to the retracted position and advances in the conveyance direction thereafter, the medium starts to be deformed to return to a state before the correction. This is because there is nothing that maintains a state after the correction before the leading end reaches the nip position.

That is, when the leading end of the medium after the correction advances from the contact position to the nip position, there is a problem in that return deformation to the state before the correction occurs.

### SUMMARY

According to an aspect of the present disclosure, there is provided a medium conveyance device including: a first conveyance roller pair configured to convey a medium in a conveyance direction; a second conveyance roller pair disposed downstream in the conveyance direction of the first conveyance roller pair and configured to convey the medium in the conveyance direction; a shutter unit including a contact section with which a leading end of the medium conveyed by the first conveyance roller pair comes into contact upstream in the conveyance direction of a nip position of the second conveyance roller pair and displaceable to a first posture for correcting skew of the medium when the leading end of the medium comes into contact with the contact section and a second posture for retracting the contact section from the medium such that the medium after the correction reaches the nip position; and a third conveyance roller pair disposed between the first conveyance roller pair and the contact section in a state of the first posture in the conveyance direction and configured to convey the medium in the conveyance direction, wherein the third conveyance roller pair does not nip the medium before the leading end of the medium comes into contact with the contact section in the first posture of the shutter unit and nips and conveys the medium after the correction and when the shutter unit is displaced from the first posture to the second posture.

According to an aspect of the present disclosure, there is provided electronic equipment including: a medium conveyance device according to any one of first to tenth aspects described below; and a processing unit disposed downstream in a conveyance direction of the medium conveyance device and configured to execute processing on the medium.

### BRIEF DESCRIPTION OF THE DRAWINGS

FIG. 1 is a partially omitted schematic configuration diagram of a recording apparatus in a first embodiment.

FIG. 2 is a main part enlarged cross-sectional view of a medium conveyance device in the first embodiment.

FIG. 3 is a main part enlarged cross-sectional view of the medium conveyance device in the first embodiment.

FIG. 4 is a main part enlarged cross-sectional view of the medium conveyance device in the first embodiment.

FIG. 5 is a plan view of a shutter unit in the first embodiment.

FIG. 6 is a main part enlarged cross-sectional view illustrating a part of an interlocking mechanism in the first embodiment.

FIG. 7 is a main part enlarged cross-sectional view illustrating another part of the interlocking mechanism in the first embodiment.

FIG. 8 is a main part enlarged cross-sectional view illustrating an operation of the interlocking mechanism in the first embodiment.

FIG. 9 is a perspective view of a driving roller of a third conveyance roller pair in the first embodiment.

FIG. 10 is a schematic perspective view illustrating one of effects of the first embodiment.

### DESCRIPTION OF EMBODIMENTS

First, the present disclosure will be schematically described.

According to a first aspect of the present disclosure, there is provided a medium conveyance device including: a first conveyance roller pair configured to convey a medium in a conveyance direction; a second conveyance roller pair disposed downstream in the conveyance direction of the first conveyance roller pair and configured to convey the medium in the conveyance direction; a shutter unit including a contact section with which a leading end of the medium conveyed by the first conveyance roller pair comes into contact upstream in the conveyance direction of a nip position of the second conveyance roller pair and displaceable to a first posture for correcting skew of the medium when the leading end of the medium comes into contact with the contact section and a second posture for retracting the contact section from the medium such that the medium after the correction reaches the nip position; and a third conveyance roller pair disposed between the first conveyance roller pair and the contact section in a state of the first posture in the conveyance direction and configured to convey the medium in the conveyance direction, wherein the third conveyance roller pair does not nip the medium before the leading end of the medium comes into contact with the contact section in the first posture of the shutter unit and nips and conveys the medium after the correction and when the shutter unit is displaced from the first posture to the second posture.

Here, “nips the medium when the shutter unit is displaced from the first posture to the second posture” in “nips and conveys the medium after the correction and when the shutter unit is displaced from the first posture to the second posture” is used to mean that the third conveyance roller pair nips the medium in a state in which the skew of the medium is corrected by the shutter unit in the first posture, that is, before the shutter unit is displaced from the first posture to the second posture.

According to this aspect, the third conveyance roller pair disposed between the first conveyance roller pair and the contact section in the conveyance direction is provided, and the third conveyance roller pair is configured not to nip the medium before the leading end of the medium comes into contact with the contact section in the first posture of the shutter unit and to nip and convey the medium after the correction and when the shutter unit is displaced from the first posture to the second posture.

Accordingly, after the correction of the skew, the third conveyance roller pair nips the medium in a state after the correction. After the correction of the skew, when the shutter unit is displaced from the first posture to the second posture, the leading end of the medium advances toward the nip position of the second conveyance roller pair. When the leading end of the medium advances, since return deformation of the medium to a state before the correction is restricted by the nip by the third conveyance roller pair, the medium can be nipped by the second conveyance roller pair in the state after the correction. That is, since the return deformation to the state before the correction is restricted before the medium is nipped by the second conveyance roller pair after the correction, the second conveyance roller pair can convey the medium in the state after the correction.

According to a second aspect of the present disclosure dependent from the first aspect, in the medium conveyance device according to the first aspect, the third conveyance roller pair may include a driving roller and a driven roller, the driven roller may be displaceable to a contact position where the driven roller comes into contact with the driving roller and a retracted position where the driven roller is separated from the driving roller, and the driven roller may be located at the retracted position before the leading end of the medium comes into contact with the contact section in the first posture of the shutter unit and may be displaced to the contact position in a state in which the shutter unit is in the first posture after the correction.

According to this aspect, the third conveyance roller pair includes the driving roller and the driven roller. The driven roller is displaceable to the contact position where the driven roller comes into contact with the driving roller and the retracted position where the driven roller is separated from the driving roller. The driven roller is configured to be located at the retracted position before the leading end of the medium comes into contact with the contact section in the first posture of the shutter unit and to be displaced to the contact position in the state in which the shutter unit is in the first posture after the correction. Accordingly, the effect of the first aspect can be obtained by a simple structure in which the driven roller is displaced between the retracted position and the contact position.

According to a third aspect of the present disclosure, in the medium conveyance device according to the first aspect, driving of the third conveyance roller pair may be synchronized with driving of the second conveyance roller pair.

Note that this aspect can also be dependent from the second aspect.

According to this aspect, since the driving of the third conveyance roller pair is synchronized with the driving of the second conveyance roller pair, it is possible to stabilize a conveyance property of the medium.

According to a fourth aspect of the present disclosure dependent from the second aspect, in the medium conveyance device according to the second aspect, the medium conveyance device further may include an interlocking mechanism configured to interlock the displacement of the driven roller and the displacement of the shutter unit, and the interlocking mechanism may displace the shutter unit from the first posture to the second posture in association with displacement of the driven roller from the retracted position to the contact position.

Note that this aspect can also be dependent from the third aspect.

According to this aspect, the medium conveyance device includes the interlocking mechanism configured to interlock the displacement of the driven roller and the displacement of the shutter unit. The interlocking mechanism is configured to displace the shutter unit from the first posture to the second posture in association with the displacement of the driven roller from the retracted position to the contact position. Accordingly, an operation of the displacement of the driven roller and the displacement of the shutter unit can be implemented by a single driving unit.

According to a fifth aspect of the present disclosure dependent from the fourth aspect, in the medium conveyance device according to the fourth aspect, the interlocking mechanism may include: a phase difference cam configured to couple the driven roller and the shutter unit to be capable of transmitting power; and a displacement force applying section configured to apply a displacement force for displacing the driven roller, and, after the correction, the phase difference cam may displace only the driven roller from the retracted position to the contact position based on the displacement force and subsequently displace the shutter unit from the first posture to the second posture based on the displacement force.

According to this aspect, the interlocking mechanism includes the phase difference cam configured to couple the driven roller and the shutter unit to be capable of transmitting power and the displacement force applying section configured to apply the displacement force for displacing the driven roller. The phase difference cam is configured to displace only the driven roller from the retracted position to the contact position based on the displacement force after the correction and subsequently displace the shutter unit from the first posture to the second posture based on the displacement force.

Accordingly, it is possible to perform the correction of the medium in the state in which the shutter unit is in the first posture and, in the state after the correction, displace, with the phase difference cam, only the driven roller from the retracted position to the contact position based on the displacement force of the displacement force applying section first to bring the medium in a nipped state. Subsequently, it is possible to displace, with the phase difference cam, the shutter unit from the first posture to the second posture based on the displacement force.

According to a sixth aspect of the present disclosure dependent from the fifth aspect, in the medium conveyance device according to the fifth aspect, the phase difference cam may include: a first cam base section fixed to the shutter unit side; a second cam base section provided on the driven roller side and turnable in a state of facing the first cam base section; a long groove provided in the first cam base section or the second cam base section; and a protrusion provided in the first cam base section or the second cam base section in which the long groove is not provided, the protrusion being movably engaged in the long groove, and the medium conveyance device may further include: a turnable turning arm, one end of which is attached to the second cam base section; and an elastic member attached to a part of the turning arm separated from the second cam base section, and the driven roller may be held by the elastic member and may be displaced between the retracted position and the contact position when the turning arm turns with the displacement force.

According to this aspect, the phase difference cam includes the first cam base section and the second cam base section that is rotatable in the state of facing the first cam base section and includes the long groove provided in the first cam base section or the second cam base section and the protrusion provided in the first cam base section or the second cam base section in which the long groove is not provided, the protrusion being movably engaged in the long groove. The medium conveyance device further includes the turnable turning arm, one end of which is attached to the second cam base section, and the elastic member attached to the part of the turning arm separated from the second cam base section, and the driven roller is held by the elastic member and is configured to be displaced between the retracted position and the contact position when the turning arm turns with the displacement force.

Accordingly, the phase difference cam can be implemented by a simple structure including the first cam base section, the second cam base section, the long groove, and the protrusion as elements. Further, the displacement of the driven roller between the retracted position and the contact position can be implemented by the turning arm with a simple structure.

It is possible to perform the correction of the medium in the state in which the shutter unit is in the first posture and, in the state after the correction, displace only the driven roller from the retracted position to the contact position to bring the medium into a nipped state by moving the protrusion via the turning arm with the displacement force of the displacement force applying section. Subsequently, in the state after the correction, it is possible to further move the protrusion with the displacement force to move the long groove to thereby displace the shutter unit from the first posture to the second posture.

Further, since the driven roller is held on the turning arm by the elastic member, when both of the protrusion and the long groove are moved after only the protrusion is moved, a force acts on the driven roller in a direction of further pressing the driven roller against the driving roller by further turning the turning arm. However, since the pressing force is absorbed by the elastic deformation of the elastic member, the pressing force for the driven roller against the driving roller can be kept within an appropriate range.

According to a seventh aspect of the present disclosure dependent from the second aspect, in the medium conveyance device according to the second aspect, after the second conveyance roller pair nips the medium, the driven roller may be displaced to the retracted position in a state in which the shutter unit is in the second posture.

Note that this aspect can also be dependent from any one of the third to sixth aspects.

According to this aspect, after the second conveyance roller pair nips the medium, the driven roller is displaced to the retracted position in the state in which the shutter unit is in the second posture. Accordingly, it is unnecessary to control the driving of the third conveyance roller pair, and overall control for conveying the medium is facilitated.

According to an eighth aspect of the present disclosure dependent from the second aspect, in the medium conveyance device according to the second aspect, the driving roller may include: a shaft; and a plurality of roller sections fixed to the shaft.

Note that this aspect can also be dependent from any one of the third to seventh aspects.

According to this aspect, the driving roller includes the shaft and the plurality of roller sections fixed to the shaft. That is, in the driving roller, the shaft and the roller sections integrally rotate. Accordingly, when the roller sections come into contact with the driven roller, since rotational deviation does not occur, conveyance in a state in which the medium is nipped by the third conveyance roller pair is stabilized.

According to a ninth aspect of the present disclosure dependent from the second aspect, in the medium conveyance device according to the second aspect, the driven roller may be a toothed roller.

Note that this aspect can also be dependent from any one of the third to eighth aspects.

Here, the “toothed roller” is a roller having structure in which a large number of teeth are present on the outer surface and come into point contact with the medium. The toothed roller is sometimes referred to as “serrated roller”.

According to this aspect, since the driven roller is the toothed roller, a contact area with the medium can be reduced. In particular, when recording is performed on both surfaces of the medium, a contact area with the recorded surface can be reduced.

According to a tenth aspect of the present disclosure dependent from the first aspect, in the medium conveyance device according to the first aspect, the medium conveyance device may further include a reversing path disposed downstream in the conveyance direction of the second conveyance roller pair, the medium reversing and merging with the conveyance path again on the reversing path.

Note that this aspect can also be dependent from any one of the second to ninth aspects.

According to this aspect, the medium conveyance device includes the reversing path on which the medium reverses and merges with the conveyance path again is provided. Accordingly, for example, when processing such as recording is performed downstream of the second conveyance roller pair and thereafter recording is performed on both the surfaces via the reversing path, it is possible to correct the skew even for a wavy medium generated when recording is performed on one surface and it is possible to further restrict return deformation to a state before the correction of the skew.

Electronic equipment according to an eleventh aspect of the present disclosure includes: the medium conveyance device according to any one of the first to tenth aspects; and a processing unit disposed downstream in the conveyance direction of the medium conveyance device and configured to execute processing on the medium.

According to this aspect, the electronic equipment such as a printer can obtain the effect obtained by the medium conveyance device according to any one of the first to the tenth aspects.

### EMBODIMENTS

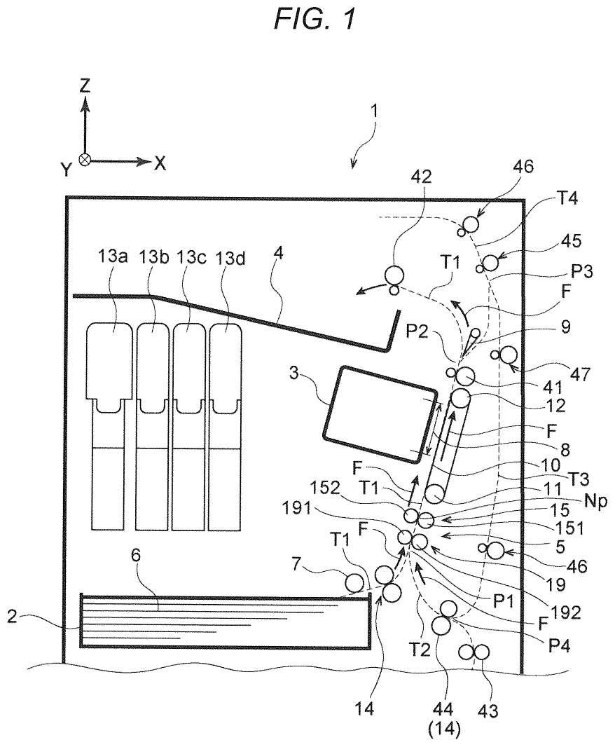

Hereinafter, a medium conveyance device and electronic equipment including the medium conveyance device according to an embodiment of the present disclosure are specifically explained with reference to FIGS. 1 to 10. Here, a case in which the electronic equipment is a recording apparatus such as an inkjet printer is explained.

In the following explanation, three axes orthogonal to one another are respectively represented as an X axis, a Y axis, and a Z axis as illustrated in the figures. Directions indicated by arrows of the three axes (X, Y, and Z) are + directions of the directions and the opposite directions of the directions are − directions. The Z-axis direction is equivalent to the vertical direction, that is, a direction in which the gravity acts, the +Z direction indicates the vertically upward direction and the −Z direction indicates the vertically downward direction. The X-axis direction and the Y-axis direction are equivalent to the horizontal direction. The +Y direction indicates the front direction of the recording apparatus and a −Y direction indicates the rear direction of the recording apparatus. The +X direction indicates the right direction of the recording apparatus and the −X direction indicates the left direction of the recording apparatus.

### First Embodiment

### Overall Schematic Explanation of the Recording Apparatus

A recording apparatus 1 in the present embodiment is an inkjet printer as an example.

As illustrated in FIG. 1, the recording apparatus 1 includes a medium cassette 2, a conveyance path T1, a recording unit 3, a discharge receiving unit 4, and a medium conveyance device 5.

Media 6 such as paper are stored in the medium cassette 2. A medium 6 in the medium cassette 2 is picked by a pick roller 7 and thereafter receives a conveyance force from the medium conveyance device 5 and is conveyed in a conveyance direction F on a conveyance path T1. The recording unit 3 is an example of a processing unit that executes processing on the medium 6. The recording unit 3 executes recording by discharge of ink as processing on the medium 6 when the medium 6 passes through a recording execution region 8 in the conveyance path T1. The medium 6 on which the recording has been executed by the recording unit 3 is discharged to the discharge receiving unit 4. The medium conveyance device 5 is explained below.

The recording apparatus 1 includes not-illustrated another medium cassette below the medium cassette 2. The medium 6 picked from another medium cassette is conveyed on another conveyance path T2. The other conveyance path T2 merges with the conveyance path T1 at a merging point P1. The recording apparatus 1 further includes a reversing path T3 and a switchback path T4 for performing recording on both the surfaces.

In the recording execution region 8 of the recording unit 3, the medium 6 is conveyed in the conveyance direction F in a state of being supported by a conveyor belt 10 forming a part of the medium conveyance device 5. The conveyor belt 10 is an endless belt wound around a pulley 11 and a pulley 12 and rotates when at least one of the pulley 11 and the pulley 12 is driven by a not-illustrated motor.

In the present embodiment, the recording unit 3 is a line head elongated in the width direction (the Y-axis direction) of the medium 6. The recording unit 3 is not limited to the line head and may be a serial type head that reciprocates in a direction intersecting the conveyance direction F.

Reference signs 13a, 13b, 13c, and 13d denote ink storage units that store ink. The ink discharged from the recording unit 3 is supplied from the ink storage units 13a, 13b, 13c, and 13d to the recording unit 3 via a not-illustrated tube.

A recording execution operation of the recording unit 3 on the medium 6 and a conveyance operation of the medium 6 by the medium conveyance device 5 are performed by a not-illustrated control unit. The control unit includes a CPU, a flash ROM, and a RAM. The CPU performs various kinds of arithmetic processing according to programs stored in the flash ROM and controls an operation of the entire recording apparatus 1. The flash ROM, which is an example of storage means, is a readable and writable nonvolatile memory. The RAM, which is an example of storage means, temporarily stores various information.

### Medium Conveyance Device

Subsequently, a configuration of the medium conveyance device 5 according to the first embodiment is explained with reference to FIGS. 1 to 9.

The medium conveyance device 5 includes a first conveyance roller pair 14 (FIG. 1) that conveys the medium 6 downstream in the conveyance direction F and a second conveyance roller pair 15 (FIG. 1) that is disposed downstream of the first conveyance roller pair 14 in the conveyance direction F and conveys the medium 6 downstream in the conveyance direction F. The conveyance path T1 includes the first conveyance roller pair 14, the second conveyance roller pair 15, the conveyor belt 10, and other conveyance roller pairs 41 and 42. A feed roller and a separation roller for preventing double feed of the media 6 and feeding the media 6 one by one in the conveyance direction F are usually provided between the pick roller 7 and the first conveyance roller pair 14 but are not illustrated in the figures.

The conveyance path T2 includes the other conveyance roller pairs 43 and 44. When the medium 6 is conveyed on the conveyance path T2 toward the recording execution region 8, the conveyance roller pair 44 disposed upstream of the second conveyance roller pair 15 functions as the first conveyance roller pair 14.

In the present embodiment, the recording apparatus 1 further includes a reversing path T3 and a switchback path T4 for performing recording on both the surfaces.

The switchback path T4 branches from the conveyance path T1 at a branch point P2. The branch point P2 is located further downstream in the conveyance direction than the recording unit 3. The switchback path T4 includes conveyance roller pairs 45 and 46 for switchback. The conveyance roller pairs 45 and 46 for the switchback path T4 are configured to be capable of forward rotation and reverse rotation. A flap 9 is disposed at the branch point P2 and the conveyance direction of the medium 6 is switched.

One end side of the reversing path T3 merges with the switchback path T4 at a merging point P3 and the other end side of the reversing path T3 merges with the other conveyance path T2 at a merging point P4. The reversing path T3 includes conveyance roller pairs 47 and 48 for the reversing path.

The “conveyance roller pair” includes a pair of a driving roller driven to rotate by a not-illustrated motor and a driven roller rotates in contact with and following the driving roller. However, a part or the entire driven roller may be configured by the driving roller according to design specifications.

When recording is performed on both the surfaces of the medium 6, the medium 6, on the first surface of which recording has been executed, is sent to the switchback path T4 by switching the flap 9 at the branch point P2. The conveyance of the medium 6 conveyed on the switchback path T4 is stopped after the trailing end of the medium 6 passes through the position of the merging point P3 and the medium 6 remains in the switchback path T4.

Subsequently, the conveyance roller pairs 45 and 46 for the switchback path T4 rotate in the opposite direction and the medium 6 is sent to the reversing path T3 through the merging point P3. Then, the medium 6 passes through the merging point P4 and the merging point P1, is nipped by the second conveyance roller pair 15, and is conveyed toward the recording execution region 8.

Shutter unit

The medium conveyance device 5 further includes a shutter unit 17.

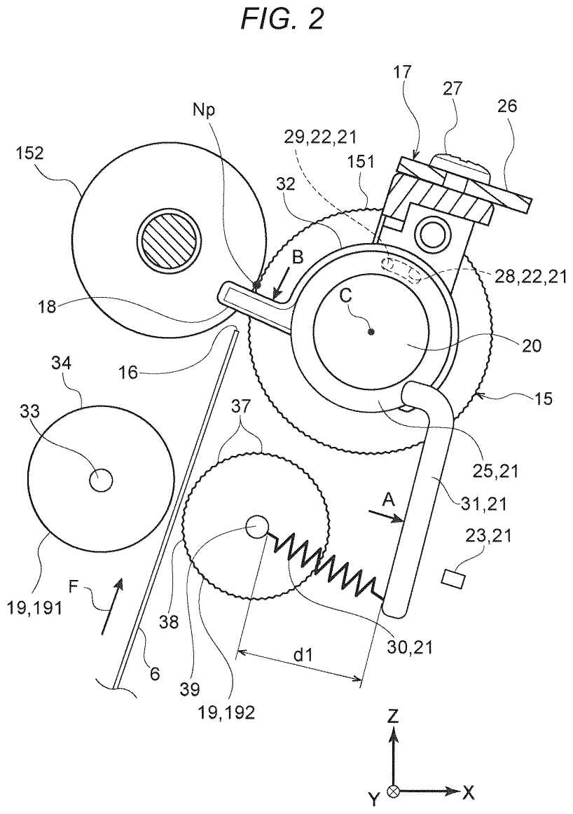

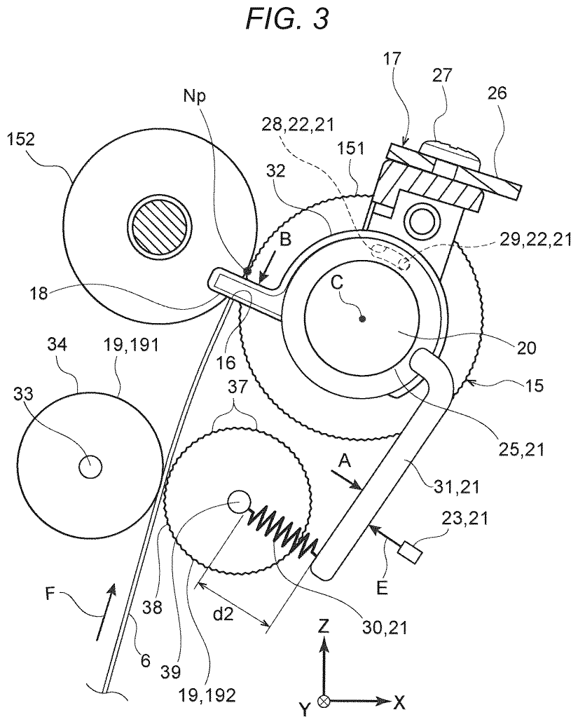

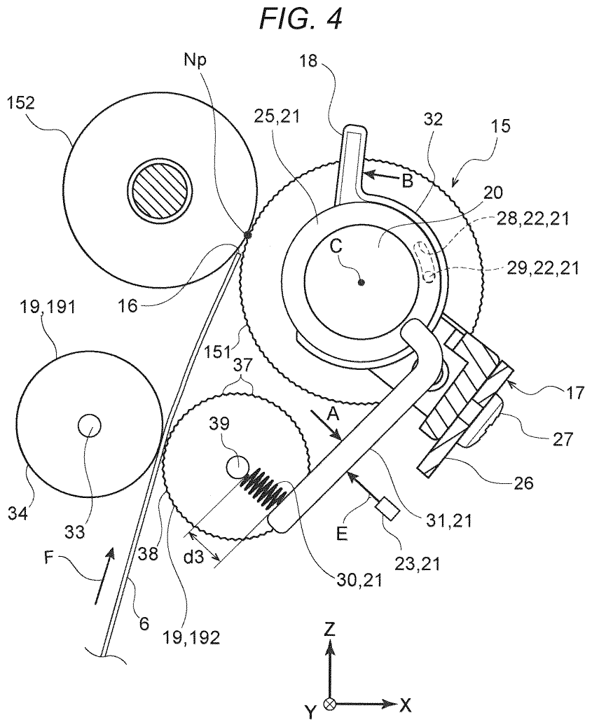

As illustrated in FIGS. 1 to 4, the shutter unit 17 is configured to be displaceable to a first posture (FIGS. 2 and 3) for correcting skew of the medium 6 when a leading end 16 (FIG. 2) of the medium 6 conveyed by the first conveyance roller pair 14 comes into contact with a contact section 18 upstream in the conveyance direction F of a nip position Np (FIG. 2) of the second conveyance roller pair 15 and a second posture (FIG. 4) in which the medium 6 after the correction is retracted from the medium 6 to reach the nip position Np.

The nip position Np is disposed at a position where the leading end 16 of the medium 6, the skew of which has been corrected in the contact section 18, is immediately nipped by the second conveyance roller pair 15.

The shutter unit 17 is rotatably disposed on a rotating shaft 20 of one second conveyance roller 151 of the second conveyance roller pair 15. In FIG. 2, a reference numeral 152 denotes the other second conveyance roller of the second conveyance roller pair 15.

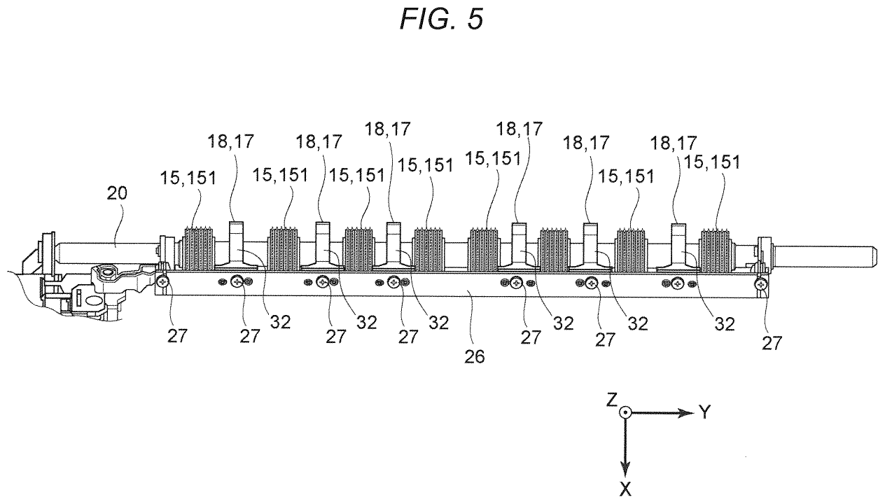

FIG. 5 is a plan view of the shutter unit 17 rotatably disposed on the rotating shaft 20. The shutter unit 17 includes a plurality of contact sections 18 with which the leading end 16 of the medium 6 comes into contact and an elongated base section 26 to which the contact sections 18 are attached by screws 27.

The plurality of contact sections 18 are attached to the base section 26 by the screws 27 via a semi-cylindrical rotating member 32 (FIG. 2). The semi-cylindrical rotating member 32 is configured to slide and rotate on the cylindrical outer surface of the rotating shaft 20 such that the contact sections 18 can be displaced between the first posture (FIGS. 2 and 3) and the second posture (FIG. 4). That is, the shutter unit 17 is configured to rotate with a center C of the rotating shaft 20 as a rotation center.

As illustrated in FIGS. 2 to 4, the medium conveyance device 5 in the present embodiment is configured to apply a pressing force B to the shutter unit 17 with a not-illustrated pressing force action section to cause the shutter unit 17 to take the first posture (FIGS. 2 and 3). Displacement from the state of the first posture (FIGS. 2 and 3) to the second posture (FIG. 4) is performed by causing a displacement force against the pressing force B to act on the shutter unit 17. This point is explained below.

The pressing force action section is not limited to a pressing force action section having specific structure if the pressing force action section can generate the pressing force B. Here, the pressing force action section is made of an elastic member such as a coil spring and configured such that the pressing force B for pressing the shutter unit 17 against a section to be pressed (not illustrated) is generated by an elastic force of the elastic member.

### Third Conveyance Roller Pair

As illustrated in FIGS. 1 to 4, in the present embodiment, a third conveyance roller pair 19 is disposed between the first conveyance roller pair 14 and the contact section 18 in the state of the first posture in the conveyance direction F. The third conveyance roller pair 19 conveys the medium 6 in the conveyance direction F.

The third conveyance roller pair 19 is configured to be in a state (FIG. 2) of not nipping the medium 6 before the leading end 16 of the medium 6 comes into contact with the contact section 18 in the first posture (FIGS. 2 and 3) of the shutter unit 17. The third conveyance roller pair 19 is configured to come into a state (FIG. 3) of nipping the medium 6 to be able to convey the medium 6 when the shutter unit 17 is displaced from the first posture (FIGS. 2 and 3) to the second posture (FIG. 4) after the leading end 16 of the medium 6 comes into contact with the contact section 18 and the skew of the medium 6 is further corrected, that is, after the correction of the medium 6.

In other words, the third conveyance roller pair 19 is configured to nip the medium 6 in a state in which the skew of the medium 6 is corrected by the shutter unit 17 in the first posture (FIGS. 2 and 3). That is, the third conveyance roller pair 19 is configured to nip the medium 6 before the shutter unit 17 is displaced from the first posture (FIGS. 2 and 3) to the second posture (FIG. 4). The third conveyance roller pair 19 is disposed near the second conveyance roller pair 15 to be able to nip the medium 6 in a state in which the skew is corrected.

In the present embodiment, driving of the third conveyance roller pair 19 is synchronized with driving of the second conveyance roller pair 15. That is, conveyance speed at which the third conveyance roller pair 19 conveys the medium 6 is set the same as conveyance speed at which the second conveyance roller pair 15 conveys the medium 6.

In the present embodiment, the third conveyance roller pair 19 includes a driving roller 191 and a driven roller 192. The driven roller 192 is configured to be displaceable between a contact position (FIG. 3) where the driven roller 192 comes into contact with the driving roller 191 and a retracted position (FIG. 2) where the driven roller 192 is separated from the driving roller 191.

That is, the driven roller 192 is configured to be located at the retracted position (FIG. 2) before the leading end 16 of the medium 6 comes into contact with the contact section 18 in the first posture (FIGS. 2 and 3) of the shutter unit 17 and to be displaced to the contact position (FIG. 3) in a state in which the shutter unit 17 is in the first posture (FIGS. 2 and 3) after the correction of the medium 6.

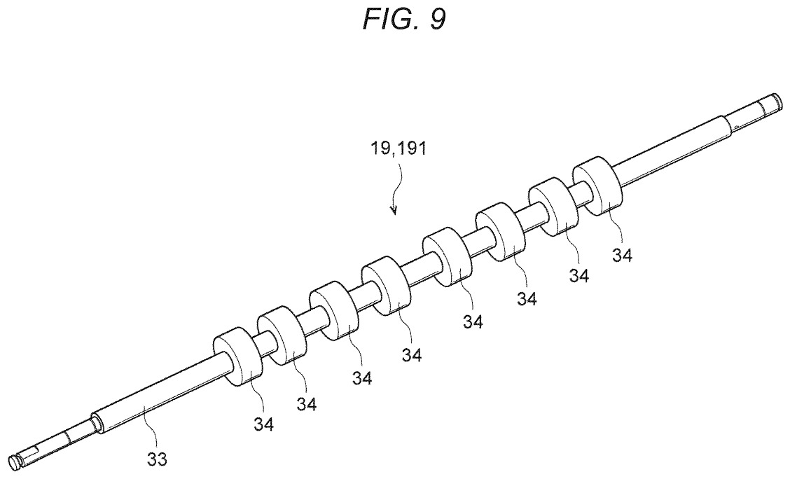

As illustrated in FIG. 9, in the present embodiment, the driving roller 191 includes a shaft 33 and a plurality of roller sections 34, 34, . . . fixed to the shaft 33. The roller sections 34, 34, . . . are made of a rubber material.

The driven roller 192 is formed of a toothed roller 38. The toothed roller 38 is a roller having structure in which a large number of teeth 37, 37, . . . are present on the outer surface and are in point contact with the medium 6. A plurality of driven rollers 192 are rotatably attached to one shaft 39 to correspond to the plurality of roller sections 34, 34, . . . of the driving roller 191.

### Interlocking Mechanism

In the present embodiment, the medium conveyance device 5 includes an interlocking mechanism 21 that interlocks displacement of the driven roller 192 and displacement of the shutter unit 17. That is, the interlocking mechanism 21 is configured to displace the shutter unit 17 from the first posture (FIGS. 2 and 3) to the second posture (FIG. 4) in association with the displacement of the driven roller 192 from the retracted position (FIG. 2) to the contact position (FIGS. 3 and 4).

As illustrated in FIGS. 2 to 4, the interlocking mechanism 21 includes a phase difference cam 22 that couples the driven roller 192 and the shutter unit 17 to be capable of transmitting power and a displacement force applying section 23 that applies a displacement force E for displacing the driven roller 192. The displacement force applying section 23 only has to be a structure capable of generating the displacement force E and is not limited to a specific structure. Here, the displacement force applying section 23 is configured to generate the displacement force E using a solenoid as a power source.

After the correction of the medium 6, the phase difference cam 22 is configured to displace only the driven roller 192 from the retracted position (FIG. 2) to the contact position (FIGS. 3 and 4) based on the displacement force E and subsequently displace the shutter unit 17 from the first posture (FIGS. 2 and 3) to the second posture (FIG. 4) based on the displacement force E.

### Phase Difference Cam and Turning Arm

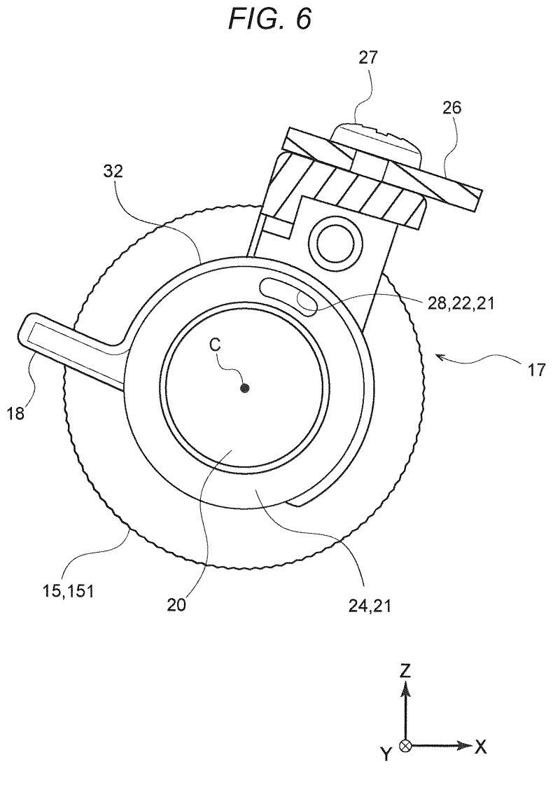

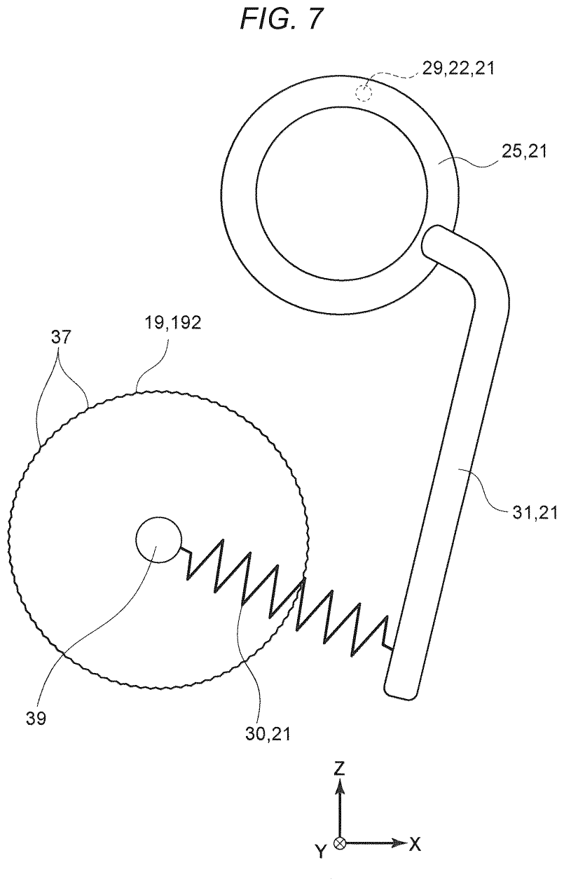

As illustrated in FIGS. 6 and 7, in the present embodiment, the phase difference cam 22 includes a first cam base section 24 (FIG. 6) fixed to the shutter unit 17 side and a second cam base section 25 (FIG. 7) provided on the driven roller 192 side and rotatable around the rotating shaft 20 in a state of facing the first cam base section 24. A long groove 28 is provided in the first cam base section 24. A protrusion 29 is provided in the second cam base section 25. The protrusion 29 is movably engaged with the long groove 28. The protrusion 29 may be provided in the first cam base section 24 and the long groove 28 may be provided in the second cam base section 25.

Furthermore, in the present embodiment, the phase difference cam 22 includes a turnable turning arm 31, one end of which is attached to the second cam base section 25, and an elastic member 30 attached to a part of the turning arm 31 separated from the second cam base section 25.

The driven roller 192 is held by the elastic member 30. The driven roller 192 is configured to be displaced from the retracted position (FIG. 2) to the contact position (FIGS. 3 and 4) when the turning arm 31 turns with the rotating shaft 20 as a fulcrum with the displacement force E of the displacement force applying section 23.

As illustrated in FIGS. 2 to 4, the medium conveyance device 5 in the present embodiment is configured to apply a pressing force A to the turning arm 31 with a not-illustrated pressing force action section and pressing the turning arm 31 side against a not-illustrated section to be pressed to locate the driven roller 192 at the retracted position (FIG. 2).

The driven roller 192 is displaced from the retracted position (FIG. 2) to the contact position (FIG. 3) by causing the displacement force E resisting the pressing force A to act on the turning arm 31.

In the present embodiment, a set of the phase difference cam 22 and the turning arm 31 configuring the interlocking mechanism 21 is provided in each of the rotating members 32 of the plurality of contact sections 18. However, the set of the phase difference cam 22 and the turning arm 31 is not limited thereto. The set of the phase difference cam 22 and the turning arm 31 configuring the interlocking mechanism 21 may be provided on the rotating members 32 of at least two contact sections 18. In this case, it is preferable to provide the set of the phase difference cam 22 and the turning arm 31 in the rotating member 32 of two contact sections 18 located most distant from each other.

In the present embodiment, the elastic member 30 is provided for each of the plurality of driven rollers 192. However, not only this, but at least two elastic members 30 may be provided. In that case, it is preferable to provide one elastic member 30 at each of both the end portions of the shaft 39.

As illustrated in FIGS. 2 to 4, in the present embodiment, the turning arm 31 is configured such that the displacement force E is applied from the displacement force applying section 23. Since the displacement force E has a function of displacing the driven roller 192, the displacement force E may be applied to, for example, the second cam base section 25 that is another constituent member other than turning arm 31.

After the correction of the medium 6, the turning arm 31 receives the displacement force E and turns resisting the pressing force A. According to this rotation, the protrusion 29 moves in the long groove 28.

By the movement of the protrusion 29, the driven roller 192 is displaced from the retracted position (FIG. 2) to the contact position (FIG. 3) to nip the medium 6. At this time, when the length of the elastic member 30 in a state of being in the retracted position (FIG. 2) is represented as d1, the length at the contact position (FIG. 3) changes to d2. The length d2 is smaller than the length d1. This is because the driven roller 192 comes into contact with and is pressed against the driving roller 191.

Subsequently, when the turning arm 31 receives the displacement force E and further turns resisting the pressing force A and the pressing force B, the protrusion 29 moves the long groove 28.

The shutter unit 17 is displaced from the first posture (FIG. 3) to the second posture (FIG. 4) by the movement of the long groove 28. At this time, the length of the elastic member 30 changes to d3. The length of the elastic member 30 in a state in which the shutter unit 17 is present in the first posture (FIG. 3) is d2. The length d3 is smaller than the length d2. This is because the turning arm 31 further turns in a state in which the driven roller 192 is in contact with the driving roller 191 and cannot move.

The shutter unit 17 is displaced from the first posture (FIGS. 2 and 3) to the second posture (FIG. 4) as explained below.

The shutter unit 17 is configured to receive the action of the displacement force E of the displacement force applying section 23 to start displacement from the first posture (FIGS. 2 and 3) to the second posture (FIG. 4) when a predetermined time t elapses after the leading end 16 of the medium 6 passes through the first conveyance roller pair 14.

The predetermined time t is set in advance as a time from when passage of the leading end 16 of the conveyed medium 6 through a nip position of the first conveyance roller pair 14 is detected by a not-illustrated sensor to when the leading end 16 comes into contact with the contact section 18 and correction of the skew ends.

In the present embodiment, after the correction of the medium 6, based on the displacement force E, only the driven roller 192 is displaced from the retracted position (FIG. 2) to the contact position (FIG. 3) first and, subsequently, the shutter unit 17 is displaced from the first posture (FIG. 3) to the second posture (FIG. 4). For that reason, immediately before the predetermined time t elapses, the displacement force E turns the turning arm and the driven roller 192 is set to be displaced from the retracted position (FIG. 2) to the contact position (FIG. 3). Accordingly, the medium 6 is nipped and held by the third conveyance roller pair 19 in a state after the correction.

Subsequently, immediately after the driven roller 192 is displaced to the contact position (FIG. 3), the shutter unit 17 is displaced from the first posture (FIGS. 2 and 3) to the second posture (FIG. 4) based on the displacement force E.

### Explanation of an Operation of the Third Conveyance Roller Pair and a Displacement Operation of the Shutter Unit

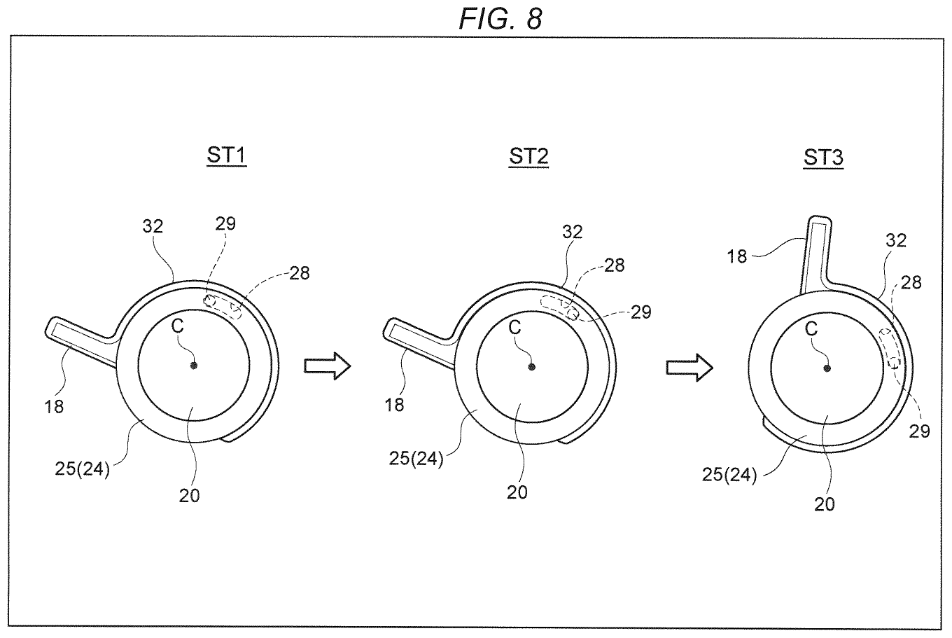

Subsequently, an operation of the third conveyance roller pair 19 and a displacement operation of the shutter unit 17 are explained with reference to FIGS. 2 to 4 and 8. The operations explained below are executed under the control of the not-illustrated control unit.
(1) The medium 6 receives a conveyance force from the first conveyance roller pair 14 (FIG. 1) of the medium conveyance device 5 and is conveyed in the conveyance direction F. FIG. 2 illustrates a state slightly before the leading end 16 of the medium 6 comes into contact with the contact section 18 of the shutter unit 17. The driven roller 192 is at the retracted position. The protrusion 29 and the long groove 28 are present at positions indicated by ST1 in FIGS. 2 and 8. Thereafter, the leading end 16 of the medium 6 comes into contact with the contact section 18 and processing for correcting skew is performed.
(2) Immediately before the predetermined time t when the correction of the skew of the medium 6 ends elapses, as illustrated in FIG. 3, the turning arm turns resisting the pressing force A with the displacement force E and the driven roller 192 is displaced from the retracted position (FIG. 2) to the contact position (FIG. 3). The position of the protrusion 29 changes to a position indicated by ST2 in FIGS. 3 and 8 but the position of the long groove 28 does not change. That is, at this point in time, the contact section 18 is present at the same position as the position in FIG. 2. Accordingly, the medium 6 is nipped by the third conveyance roller pair 19 in the state after the correction.
(3) Subsequently, when the predetermined time t elapses, the turning arm 31 further turns resisting the pressing force A and the pressing force B based on the displacement force E, and the shutter unit 17 is displaced from the first posture (FIG. 3) to the second posture (FIG. 4). The protrusion 29 and the long groove 28 change to positions illustrated in ST3 of FIGS. 4 and 8. In other words, the long groove 28 is moved by the movement of the protrusion 29, whereby the shutter unit 17 is displaced from the first posture (FIG. 3) to the second posture (FIG. 4).
(4) Since the shutter unit 17 is displaced to the second posture (FIG. 4), the medium 6 is in a state of being capable of advancing in the conveyance direction F and receives a conveyance force of the third conveyance roller pair 19 as well to be conveyed. The leading end 16 of the medium 6 reaches the nip position Np of the second conveyance roller pair 15, is nipped at the nip position Np, and is conveyed toward the recording execution region 8.
(5) After the trailing end of the medium 6 passes through the nip position Np of the second conveyance roller pair 15, the displacement force applying section 23 is set to be in an OFF state to eliminate the displacement force E. Accordingly, the turning arm 31 turns in a direction in which the turning arm 31 is returned by the pressing force A, that is, in a direction in which the driven roller 192 is separated from the driving roller 191. In other words, in a state in which the long groove 28 does not move, only the protrusion 29 moves counterclockwise in the long groove 28 from the position illustrated in FIG. 4 to the other end in the long groove 28. Accordingly, the driven roller 192 is displaced to a position away from the driving roller 191, that is, the retracted position (FIG. 2).
(6) The turning arm 31 further turns with the pressing force A and the pressing force B from the state of (5), and the protrusion 29 moves counterclockwise integrally with the long groove 28 to move to the position illustrated in FIG. 2. Accordingly, the shutter unit 17 returns to the state of the first posture (FIG. 2).

### Explanation of Effects of the Embodiment 1

(1) In the present embodiment, the third conveyance roller pair 19 disposed between the first conveyance roller pair 14 and the contact section 18 in the conveyance direction F is provided, and the third conveyance roller pair 19 is configured not to nip the medium 6 before the leading end 16 of the medium 6 comes into contact with the contact section 18 in the first posture (FIGS. 2 and 3) of the shutter unit 17 and to nip and convey the medium 6 after the correction and when the shutter unit 17 is displaced from the first posture (FIGS. 2 and 3) to the second posture (FIG. 4).

Accordingly, after correction of the skew, the third conveyance roller pair 19 nips the medium 6 in a state after the correction. After the correction of the skew, when the shutter unit 17 is displaced from the first posture (FIGS. 2 and 3) to the second posture (FIG. 4), the leading end 16 of the medium 6 advances toward the nip position Np of the second conveyance roller pair 15. At the time of the advance, since return deformation of the medium 6 to a state before the correction is restricted by the nip by the third conveyance roller pair 19, the medium 6 can be nipped by the second conveyance roller pair 15 in the state after the correction. That is, since the return deformation to the state before the correction is restricted until the medium 6 is nipped by the second conveyance roller pair 15 after the correction, the second conveyance roller pair 15 can convey the medium 6 in the state after the correction.
(2) In the present embodiment, the third conveyance roller pair 19 includes the driving roller 191 and the driven roller 192. The driven roller 192 can be displaced to the contact position (FIG. 3) where the driven roller 192 comes into contact with the driving roller 191 and the retracted position (FIG. 2) where the driven roller 192 is separated from the driving roller 191. The driven roller 192 is configured to be located at the retracted position (FIG. 2) before the leading end 16 of the medium 6 comes into contact with the contact section 18 in the first posture (FIGS. 2 and 3) of the shutter unit 17 and to be displaced to the contact position (FIG. 3) in the state in which the shutter unit 17 is in the first posture (FIG. 2) after the correction. Accordingly, the effect of the first aspect can be obtained by a simple structure in which the driven roller 192 is displaced between the retracted position (FIG. 2) and the contact position (FIG. 3).
(3) In the present embodiment, since the driving of the third conveyance roller pair 19 is synchronized with the driving of the second conveyance roller pair 15, it is possible to stabilize the conveyance property of the medium 6.
(4) In the present embodiment, the interlocking mechanism 21 that interlocks the displacement of the driven roller 192 and the displacement of the shutter unit 17 is provided. The interlocking mechanism 21 is configured to displace the shutter unit 17 from the first posture (FIGS. 2 and 3) to the second posture (FIG. 4) in association with the displacement of the driven roller 192 from the retracted position (FIG. 2) to the contact position (FIG. 3). Accordingly, operations of the displacement of the driven roller 192 and the displacement of the shutter unit 17 can be implemented by a single driving unit.
(5) In the present embodiment, the interlocking mechanism 21 includes the phase difference cam 22 that couples the driven roller 192 and the shutter unit 17 to be capable of transmitting power and the displacement force applying section 23 that applies the displacement force E for displacing the driven roller 192. After the correction, the phase difference cam 22 displaces only the driven roller 192 from the retracted position (FIG. 2) to the contact position (FIG. 3) based on the displacement force E and, subsequently, displaces the shutter unit 17 from the first posture (FIG. 3) to the second posture (FIG. 4) based on the displacement force E.

Accordingly, the correction of the medium 6 is performed in a state in which the shutter unit 17 is in the first posture (FIG. 3) and, in a state after the correction, it is possible to displace the driven roller 192 from the retracted position (FIG. 2) to the contact position (FIG. 3) first based on the displacement force E of the displacement force applying section 23 with the phase difference cam 22 to bring the medium 6 into a nipped state. Subsequently, it is possible to displace the shutter unit 17 from the first posture (FIG. 3) to the second posture (FIG. 4) based on the displacement force E with the phase difference cam 22.
(6) In the present embodiment, the phase difference cam 22 includes the first cam base section 24 and the second cam base section 25 that is rotatable in a state of facing the first cam base section 24 and includes the long groove 28 provided in the first cam base section 24 or the second cam base section 25 and the protrusion 29 that is provided in the first cam base section 24 or the second cam base section 25 in which the long groove 28 is not provided, the protrusion 29 being movably engaged in the long groove 28. Furthermore, the phase difference cam 22 includes the turnable turning arm 31, one end of which is attached to the second cam base section 25, and the elastic member 30 attached to a part of the turning arm 31 separated from the second cam base section 25, and the driven roller 192 is held by the elastic member 30 and is configured to be displaced between the retracted position (FIG. 2) and the contact position (FIG. 3) when the turning arm 31 turns with the displacement force E.

Accordingly, the phase difference cam 22 can be implemented by a simple structure including the first cam base section 24, the second cam base section 25, the long groove 28, and the protrusion 29 as elements. Further, the displacement of the driven roller 192 between the retracted position (FIG. 2) and the contact position (FIG. 3) can be implemented by the turning arm 31 with a simple structure.

The correction of the medium 6 is performed in a state in which the shutter unit 17 is in the first posture (FIG. 3) and, in a state after the correction, the protrusion 29 is moved via the turning arm 31 by the displacement force E of the displacement force applying section 23, whereby only the driven roller 192 can be displaced from the retracted position (FIG. 2) to the contact position (FIG. 3) to bring the medium 6 into a nipped state. Subsequently, in the state after the correction, the protrusion 29 is further moved by the displacement force E to move the long groove 28, whereby the shutter unit 17 can be displaced from the first posture (FIG. 3) to the second posture (FIG. 4).

Furthermore, since the driven roller 192 is held on the turning arm 31 by the elastic member 30, when both of the protrusion 29 and the long groove 28 are moved after only the protrusion 29 is moved, a force acts on the driven roller 192 in a direction of further pressing the driven roller 192 against the driving roller 191 according to further turning of the turning arm 31. However, the pressing force is absorbed by the elastic deformation of the elastic member 30, and the pressing force for the driven roller 192 against the driving roller 191 can be kept within an appropriate range.
(7) In the present embodiment, the driving roller 191 includes the shaft 33 and the plurality of roller sections 34 fixed to the shaft 33. That is, in the driving roller 191, the shaft 33 and the roller sections 34 integrally rotate. Accordingly, when the roller sections 34 come into contact with the driven roller 192, since rotational deviation does not occur, the conveyance of the medium 6 in a state of being nipped by the third conveyance roller pair 19 is stabilized.
(8) In the present embodiment, since the driven roller 192 is the toothed roller 38, a contact area with the medium 6 can be reduced. In particular, when recording is performed on both the surfaces of the medium 6, a contact area with a recorded surface can be reduced.
(9) In the present embodiment, the recording apparatus 1 includes the reversing path T3 in which the medium 6 reverses and merges the conveyance path T1 again. Accordingly, for example, when processing such as recording is performed downstream of the second conveyance roller pair 15 and, thereafter, recording is performed on both the surfaces via the reversing path T3, it is possible to correct the skew even for a wavy medium 6 generated when recording is performed on one surface and it is possible to further restrict return deformation to a state before the correction of the skew.

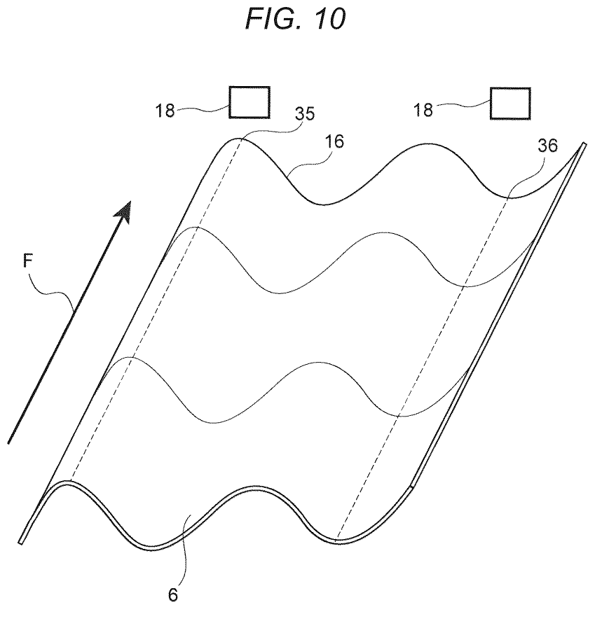

With reference to FIG. 10, it is explained that, when the shutter unit 17 retracts from a correction position after the correction of the skew, the wavy medium 6 formed by recording on both the surfaces, cockling, or the like easily causes re-skew in structure in which the third conveyance roller pair 19 of the present disclosure is not provided.

First, the leading end 16 of the wavy medium 6 comes into contact with the plurality of contact sections 18 of the shutter unit 17 to correct the skew. After the correction of the skew, the shutter unit 17 is in a state of obliquely coming into contact with the leading end 16 of the medium 6 when the contact sections 18 start to retreat from the correction position by rotating. In the case of the medium 6 that is not wavy but is in a flat state, a contact state with the oblique contact sections 18 is substantially uniform in the width direction of the leading end 16 of the medium 6. However, as illustrated in FIG. 10, in the case of the wavy medium 6, that is, when the medium 6 has a hill portion 35 and a trough portion 36 of a wave, the contact state between the oblique contact sections 18 and the leading end 16 is not the same in the hill portion 35 and the trough portion 36. Specifically, the contact state tends to be a state in which only one of the hill portion 35 and the trough portion 36 of the medium 6 tends to come into contact with the contact sections 18, that is, non-uniform. Since the contact state is such a non-uniform contact state, when the shutter unit 17 rotates and the contact sections 18 start to retract, re-skew easily occurs in the medium 6.

However, even in such a case, it is possible to suppress the occurrence of re-skew with the third conveyance roller pair 19 of the present disclosure.

### Second Embodiment

Subsequently, the medium conveyance device 5 according to a second embodiment is explained with reference to FIGS. 2 to 4. The same portions as the portions in the first embodiment are denoted by the same reference numerals and signs and explanation of configurations and effects corresponding thereto is omitted.

The present embodiment is different from the first embodiment in that the pressing force action section that applies the pressing force B is not provided, and the other components are the same as the components in the first embodiment.

In the present embodiment, the driven roller 192 is configured to, after the second conveyance roller pair 15 nips the medium 6, be displaced to the retracted position (FIG. 2) in a state in which the shutter unit 17 is in the second posture (FIG. 4).

### Explanation of an Operation of the Third Conveyance Roller Pair and a Displacement Operation of the Shutter Unit

The explanation of (1) to (4) of the first embodiment is the same in the second embodiment and (5) and the subsequent items are changed. Therefore, the explanation of (1) to (4) is omitted and (5) and the subsequent items are explained. The operations explained below are executed under the control of the not-illustrated control unit.
(5) In the present embodiment, after the leading end of the medium 6 is nipped by the second conveyance roller pair 15, the displacement force applying section 23 is set to weaken the displacement force E to a force smaller than the pressing force A. Accordingly, the turning arm 31 turns in a direction in which the turning arm 31 is returned by the pressing force A, that is, in a direction in which the driven roller 192 is separated from the driving roller 191. In this turning, the long groove 28 does not move and only the protrusion 29 moves counterclockwise in the long groove 28 from the position illustrated in FIG. 4.

The magnitude of the displacement force E is set to be equal to the magnitude of the pressing force A in a state in which the protrusion 29 moves to the other end in the long groove 28. Accordingly, only the driven roller 192 is displaced to the retracted position (FIG. 2) and the shutter unit 17 remains in the second posture (FIG. 4) since the pressing force B is not applied.

In this state, the medium 6 receives only a conveyance force of the second conveyance roller pair 15 without receiving a conveyance force of the third conveyance roller pair 19 and is conveyed in the conveyance direction F.
(6) After the trailing end of the medium 6 passes through the nip position Np of the second conveyance roller pair 15, the displacement force applying section 23 is set to the OFF state such that the displacement force E disappears. The turning arm 31 turns with the pressing force A, and the protrusion 29 moves counterclockwise integrally with the long groove 28 to move to the position illustrated in FIG. 2. Accordingly, the shutter unit 17 returns to the state of the first posture (FIG. 2).

In the present embodiment, after the third conveyance roller pair 19 nips the medium 6, the driven roller 192 is displaced to the retracted position (FIG. 2) in a state in which the shutter unit 17 is in the second posture (FIG. 4). Accordingly, it is unnecessary to control the driving of the third conveyance roller pair 19, and overall control for conveying the medium 6 is facilitated.

### Other Embodiments

The medium conveyance device 5 according to the present disclosure and the recording apparatus 1 serving as the electronic equipment including the medium conveyance device 5 basically have the configurations in embodiments explained above. However, it goes without saying that the configurations can be, for example, partially changed or omitted without departing from the gist of the present disclosure.

In the embodiments explained above, the medium conveyance device 5 is explained as having the structure in which the displacement of the driven roller 192 and the displacement of the shutter unit 17 are described as being interlocked by the interlocking mechanism 21 but is not limited to this structure. The medium conveyance device 5 may have a structure with a dedicated first driving unit that executes the displacement of the driven roller 192 and a dedicated second driving unit that executes the displacement of the shutter unit 17. That is, the medium conveyance device 5 may be configured to execute “the operation of the third conveyance roller pair and the displacement operations (1) to (6) of the shutter unit” in the first embodiment and “the operation of the third conveyance roller pair and the displacement operations (1) to (6) of the shutter unit” in the second embodiment explained above with the first driving unit and the second driving unit.

The electronic equipment including the medium conveyance device 5 is not limited to the recording apparatus 1. Examples of the electronic equipment also include, for example, an image reading apparatus such as a scanner.

What is claimed is:

1. A medium conveyance device comprising:
a first conveyance roller pair configured to convey a medium in a conveyance direction;
a second conveyance roller pair disposed downstream in the conveyance direction of the first conveyance roller pair and configured to convey the medium in the conveyance direction;
a shutter unit including a contact section with which a leading end of the medium conveyed by the first conveyance roller pair comes into contact upstream in the conveyance direction of a nip position of the second conveyance roller pair and displaceable to a first posture for correcting skew of the medium when the leading end of the medium comes into contact with the contact section and a second posture for retracting the contact section from the medium such that the medium after the correction reaches the nip position; and
a third conveyance roller pair disposed between the first conveyance roller pair and the contact section in a state of the first posture in the conveyance direction and configured to convey the medium in the conveyance direction, wherein
the third conveyance roller pair does not nip the medium before the leading end of the medium comes into contact with the contact section in the first posture of the shutter unit and nips and conveys the medium after the correction and when the shutter unit is displaced from the first posture to the second posture.

2. The medium conveyance device according to claim 1, wherein
the third conveyance roller pair includes a driving roller and a driven roller,
the driven roller is displaceable to a contact position where the driven roller comes into contact with the driving roller and a retracted position where the driven roller is separated from the driving roller, and
the driven roller is located at the retracted position before the leading end of the medium comes into contact with the contact section in the first posture of the shutter unit and is displaced to the contact position in a state in which the shutter unit is in the first posture after the correction.

3. The medium conveyance device according to claim 1, wherein driving of the third conveyance roller pair is synchronized with driving of the second conveyance roller pair.

4. The medium conveyance device according to claim 2, further comprising an interlocking mechanism configured to interlock the displacement of the driven roller and the displacement of the shutter unit, wherein
the interlocking mechanism displaces the shutter unit from the first posture to the second posture in association with displacement of the driven roller from the retracted position to the contact position.

5. The medium conveyance device according to claim 4, wherein the interlocking mechanism includes:
a phase difference cam configured to couple the driven roller and the shutter unit to be capable of transmitting power; and
a displacement force applying section configured to apply a displacement force for displacing the driven roller, and
after the correction, the phase difference cam displaces only the driven roller from the retracted position to the contact position based on the displacement force and subsequently displaces the shutter unit from the first posture to the second posture based on the displacement force.

6. The medium conveyance device according to claim 5, wherein
the phase difference cam includes:
a first cam base section fixed to the shutter unit side;
a second cam base section provided on the driven roller side and turnable in a state of facing the first cam base section;
a long groove provided in the first cam base section or the second cam base section; and
a protrusion provided in the first cam base section or the second cam base section in which the long groove is not provided, the protrusion being movably engaged in the long groove, and
the medium conveyance device further includes:
a turnable turning arm, one end of which is attached to the second cam base section; and
an elastic member attached to a part of the turning arm separated from the second cam base section, and
the driven roller is held by the elastic member and is displaced between the retracted position and the contact position when the turning arm turns with the displacement force.

7. The medium conveyance device according to claim 2, wherein, after the second conveyance roller pair nips the medium, the driven roller is displaced to the retracted position in a state in which the shutter unit is in the second posture.

8. The medium conveyance device according to claim 2, wherein the driving roller includes:
a shaft; and
a plurality of roller sections fixed to the shaft.

9. The medium conveyance device according to claim 2, wherein the driven roller is a toothed roller.

10. The medium conveyance device according to claim 1, further comprising a reversing path disposed downstream in the conveyance direction of the second conveyance roller pair, the medium reversing and merging with the conveyance path again on the reversing path.

11. Electronic equipment comprising:
the medium conveyance device according to claim 1; and
a processing unit disposed downstream in the conveyance direction of the medium conveyance device and configured to execute processing on the medium.
